(19) United States
(12) Patent Application Publication
(10) Pub. No.: US 2003/0201939 A1
(43) Pub. Date: Oct. 30, 2003

(54) Integrated dual or quad band communication and GPS band antenna

(76) Inventors: John K. Reece, Colorado Springs, CO (US); John L. Aden, Ocala, FL (US); Clinton R. Ransdell, Colorado Springs, CO (US); Douglas D. Scott, Colorado Springs, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/135,968

(22) Filed: Apr. 29, 2002

(51) Int. Cl. H01Q 1/38; H01Q 21/00

(52) U.S. Cl. 343/700 MS; 343/725

(57) ABSTRACT

An integrated antenna system including a patch antenna to receive GPS location data and a mono-bow antenna to receive mobile communication band signals. The dual antenna system is housed in a single radome and may include a radio frequency diplexer for combining the GPS location data and mobile communication signals into a single coaxial cable.

In conventional systems, the uplink Time Of Arrival (TOA) Location Measurement Unit (LMU) measures Global Positioning System (GPS) timing information. This timing information may be used to time stamp the reception of uplink bursts in a Global System for Mobile (GSM) communications network so that the TOA to multiple LMU locations may be calculated. These TOA values are processed by the LMU and sent to a Mobile Location Center (MLC) through the GSM network.

One conventional method of interface to the GSM network is through a GSM radio interface. For this method of data transfer, the TOA values may be transmitted over a GSM radio link, from the LMU to a host base station. The data may then be passed into the GSM network and on to the MLC. The collection of GPS signals and the use of a GSM radio link typically cause a separate antenna to be used for each function. Fully enclosed conventional antenna configurations use antenna separation in the horizontal plane to achieve the required RF isolation between the two antennas. The drawback to this approach is that the resulting antenna may have a very large footprint, which in turn may cause manufacturing and system integration problems. Other conventional systems with large co-linear mono-pole antennas may have the GPS antenna in a flat radome and the tall mono-pole mounted to the side of it. These are generally for mobile use and are not integrated. A further drawback of these conventional designs is that each operates within a portion of or across a single communication band only.

Therefore, what is needed is an integrated antenna system that overcomes these significant problems found in conventional antennas.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating an integrated antenna system according to an embodiment of the present invention;

FIG. 2 is a high level block diagram that illustrates the antenna system of FIG. 1;

FIG. 3 is a diagram of a GPS patch antenna on a substrate according to an embodiment of the present invention;

FIG. 4 is a diagram that illustrates an integrated antenna system according to an embodiment of the present invention;

FIG. 5 is a cutaway side view of the integrated antenna system of FIG. 3;

FIG. 6 is a cutaway side profile view of an alternative embodiment of the integrated antenna system of FIG. 1;

FIG. 7 is a cutaway side view of another alternative embodiment of the integrated antenna system of FIG. 1; and

FIG. 8 is a block diagram that illustrates a mux/demux according to an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Certain embodiments as disclosed herein provide for an integrated dual antenna system adaptable to receive Global Positioning System (GPS) location signals and mobile communication band signals, for example Global System for Mobile (GSM), Personal Communications System (PCS), cellular, and the like. The integrated antenna includes a GPS patch antenna and a mono-bow or sleeve monopole communications antenna. The integrated antenna system may be housed in a single radome and include a Radio Frequency (RF) diplexer for combining the GPS signals and the mobile communication band signals into a single coaxial cable.

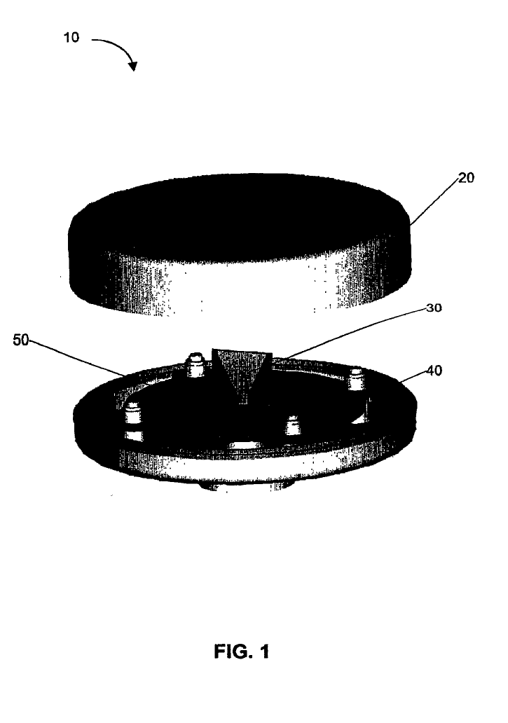

FIG. 1 is a diagram illustrating an integrated antenna system 10 according to an embodiment of the present invention. Antenna system 10 includes a radome 20, a mono-bow antenna 30, a substrate 40 and a patch antenna 50. Radome 20 covers and protects the mono-bow and patch antennas and is transparent to RF waves, thus allowing the antennas to send and receive data from within the protected area under radome 20.

It may be desirable for cost and aesthetic considerations to package mono-bow antenna 30 and patch antenna 50 within a single radome 20. Such a configuration, having both antennas housed within a single radome 20, may be required for Location Measurement Unit (LMU) type applications and may also be desirable for other applications where combinations of communication and GPS signals are desired. Some of these applications may include remote telemetry, emergency vehicle positioning, automotive location services, and fleet management.

Mono-bow antenna 30 may be one of a variety of types of monopole antennas and may be adaptable to provide omni-directional coverage and receive mobile communication band signals such as, for example, GSM and cellular communication signals. In an alternative embodiment, a generic dual-band mono-pole antenna or a sleeve mono-pole antenna may replace mono-bow antenna 30, both of which may provide dual-band characteristics and also provide additional RF coverage to the reception capability and range of antenna system 10. Alternatively, mono-bow antenna 30 may be a folded mono-bow antenna. In the illustrated embodiment, mono-bow antenna 30 may have copper on a single side and may be around 1.2 inches wide and around 1 inch tall. Mono-bow antenna 30 may also have one or more footpads (not shown) that may extend into substrate 40 to secure mono-bow antenna 30.

It should be noted that the embodiments described herein may use a sleeve mono-pole antenna in place of the mono-bow antenna 30. The advantage in using a sleeve mono-pole antenna over other types of mono-bow antennas is the increase in reception. In particular, a sleeve mono-pole antenna may add the 824 MHz to 960 MHz cellular and GSM bands to the omni-directional mobile communications band antenna. For example, a sleeve-mono bow assembly may perform as an omni-directional antenna that provides omni-directional coverage from 1710 MHz (DCS 1800) to 1990 MHz (PCS 1900) and also from 824 MHz to 960 MHz cellular and GSM bands.

Substrate 40 includes a Printed Circuit Board (PCB) that provides support for patch antenna 50 in addition to other elements of antenna system 10. Substrate 40 may include, for example, a Teflon® material, a Rogers™ duroid 5880 material, or the like. In the illustrated embodiment, substrate 40 may be roughly ⅛ inch thick and may include vias that facilitate electrical communication between the opposing surfaces of the substrate. Substrate 40 may also include through holes for supporting mono-bow antenna 30 and through holes for conductive elements (i.e. vias). The through holes that support mono-bow antenna 30 may extend partially or completely through substrate 40.

Patch antenna 50 may be a copper etched patch antenna disposed on substrate 40. Patch antenna 50 may be configured to receive GPS location data. Patch antenna 50 may be designed to have right hand circular polarization at 1,575.42 megahertz (MHz) for GPS reception. Advantageously, this arrangement with mono-bow antenna 30 mounted to the surface of patch antenna 50 and providing omni-directional coverage allows the integrated antenna to receive both GPS signals and mobile communication band signals with minimal interference between patch antenna 50 and mono-bow antenna 30.

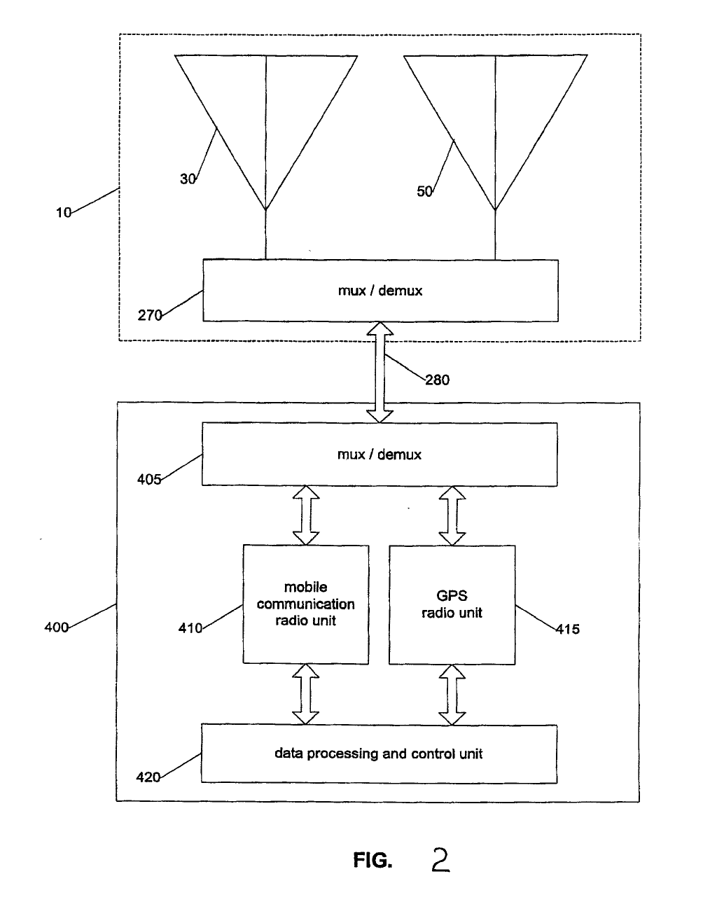

FIG. 2 is a high-level block diagram that illustrates antenna system 10 shown in FIG. 1 in communication with a conventional LMU diplexor 400. Antenna system 10 may include mono-bow antenna 30 adaptable to send and receive mobile communication band signals. Antenna system 10 may also include GPS patch antenna 50 adaptable to send and receive GPS band signals. Optionally, antenna system 10 may comprise a mux/demux 270.

The signals from mono-bow antenna 30 and GPS patch antenna 50 may be combined in mux/demux 270 and sent to LMU diplexor 400 via a single feed cable 280. Upon receipt of the combined signal at LMU diplexor 400, the signal may be processed by optional mux/demux 405 and the mobile communication band signals sent to the mobile communication radio unit 410. Correspondingly, the GPS band signals may be sent to the GPS radio unit 415. The signals may then be sent to a data processing and control unit 420 for additional processing.

In an embodiment where mux/demux 270 and the corresponding mux/demux 405 are not present, the signals from mono-bow antenna 30 may be sent to mobile communication radio unit 410 and the signals from GPS patch antenna 50 may be sent to GPS radio unit 415. Outgoing signals travel the reverse path, being combined by mux/demux 405 and then sent to antenna system 10 for processing by mux/demux 270 and ultimately for distribution by mono-bow antenna 30 or GPS patch antenna 50. In an embodiment where mux/demux 270 and the corresponding mux/demux 405 are not present, the signals from mobile communication radio unit 410 and GPS radio unit 415 may be sent to mono-bow antenna 30 and GPS patch antenna 50, respectively.

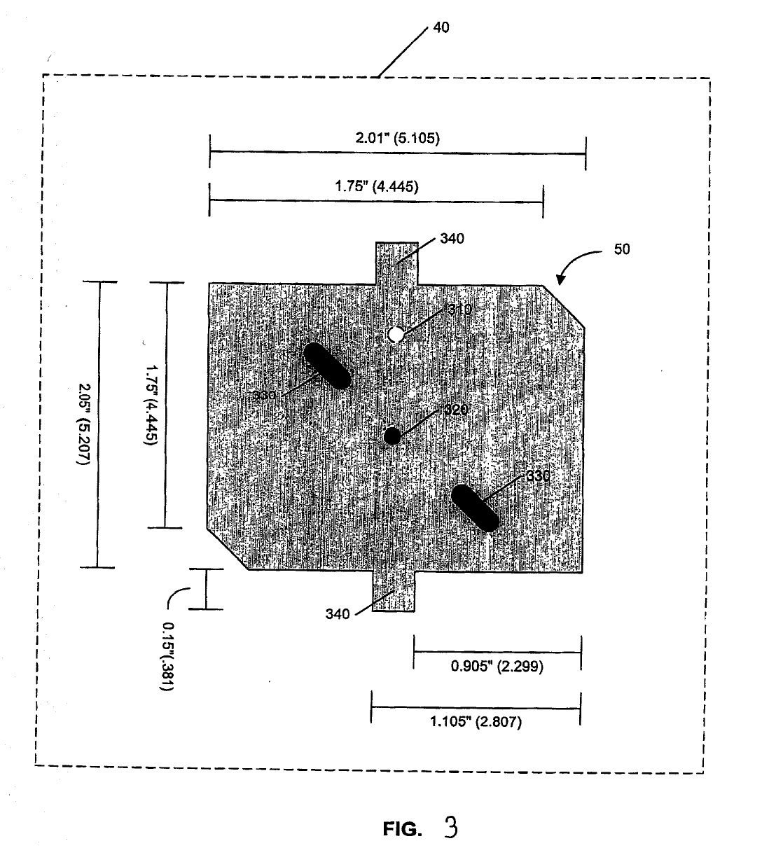

FIG. 3 is a diagram of GPS patch antenna 50 on substrate 40 according to an embodiment of the present invention. Patch antenna 50 may comprise one or more tuning tabs 340. The one or more tuning tabs may be trimmed such that patch antenna 50 receives signals at the desired frequency. Patch antenna 50 may have an antenna feed point that facilitates the patch antenna's communication through substrate 40. For example, the feed point may be disposed directly above a through hole 310 or via in substrate 40 to allow patch antenna 50 to be electrically coupled with components on the opposite side of substrate 40. Additionally, patch antenna 50 may also include a feed hole 320 for mono-bow antenna 30. Feedhole 320 may be situated directly above a through hole or via in order to provide a conduit for communications between mono-bow antenna 30 and a host device (or elements on the opposite side of substrate 40).

In the illustrated embodiment, patch antenna 50 may also include two through holes 330. Through holes 330 may provide a secure mounting area for the feet of mono-bow antenna 30 (not shown). Alternatively, patch antenna 50 may have one or more through holes 330 depending on the configuration of the particular mono-bow antenna 30. Additionally, through holes 330 may extend partially or completely through substrate 40.

GPS patch antenna 50 may have a top length of about 2.01 inches (5.105 cm) and a side length of about 2.05 inches (5.207 cm). The top length from the square edge to the cut edge may be about 1.75 inches (4.445 cm). The side length from the square edge to the cut edge may also be about 1.75 inches (4.445 cm). Midway across each of the opposing top and bottom sides of GPS patch antenna 50 may be tuning tab 340. The distance along the bottom side of GPS patch antenna 50 from the square corner to the closest edge of tuning tab 340 may be about 0.905 inches (2.299 cm). The distance along the bottom side from the square corner to the furthest edge of tuning tab 340 may be about 1.1.5 inches (2.807 cm). Finally, the depth of tuning tab 340 on the bottom side of GPS patch antenna 50 may be about 0.15 inches (0.381 cm). It should be noted that these dimensions are exemplary and should not be used to limit the invention.

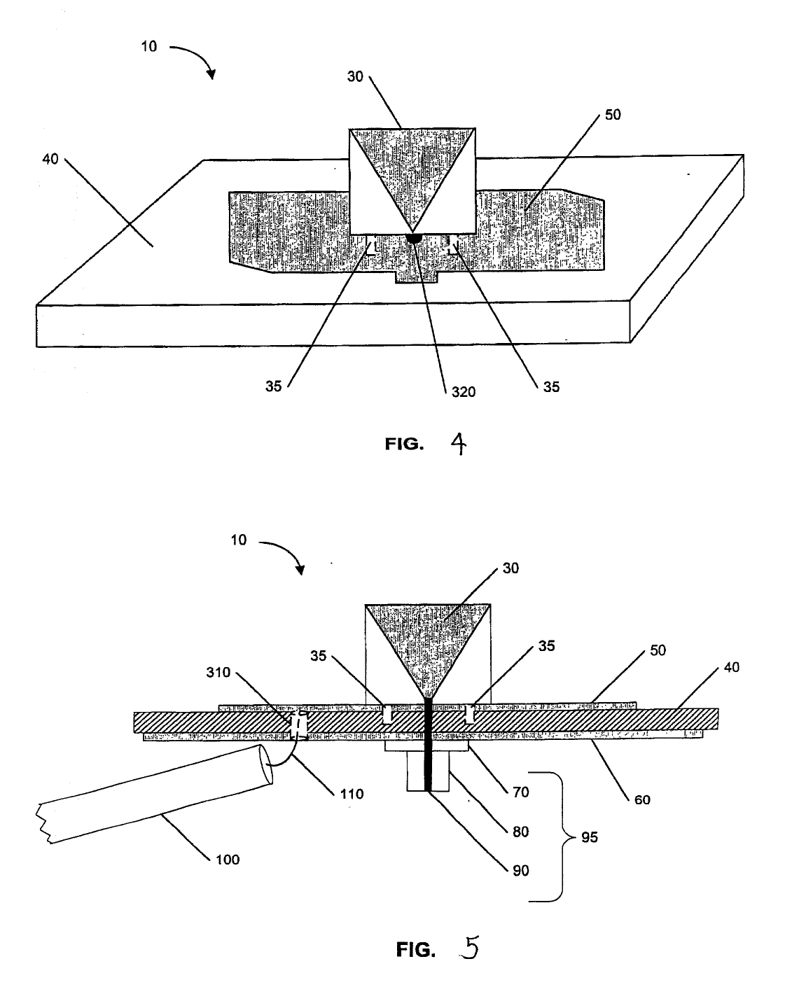

FIG. 4 is a diagram that illustrates integrated antenna system 10 according to an embodiment of the present invention. Antenna system 10 may include mono-bow antenna 30 which may be secured to substrate 40 using footpads 35 that may extend into substrate 40. Antenna system 10 may additionally include patch antenna 50 having through holes (not shown) that allow footpads 35 to extend through patch antenna 50. Furthermore, patch antenna 50 may contain a feed hole 320 that provides a conduit for communications between mono-bow antenna 30 and a host device (or elements on the opposite side of substrate 40).

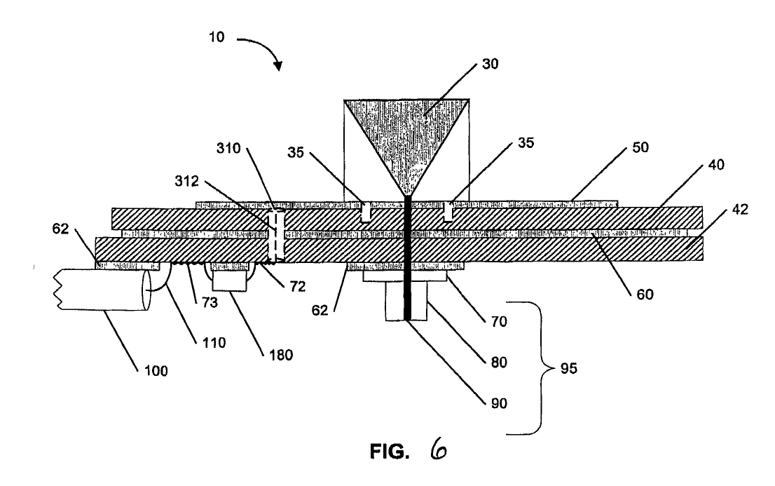

FIG. 5 is a cutaway side view of integrated antenna system 10 of FIG. 3. The illustrated embodiment includes mono-bow antenna 30 and patch antenna 50 supported by substrate 40. Mono-bow antenna 30 may have two footpads 35 that extend through patch antenna 50, allowing the antenna to be mounted on patch antenna 50. As an alternative to foot pads 35, mono-bow antenna 30 may employ one or more mounting blocks (not shown). Mounting mono-bow antenna 30 at a 90-degree angle to substrate 40 may assist the omni-directional capabilities of mono-bow antenna 30. In the illustrated embodiment, a single substrate 40 is shown, but in alternative embodiments, antenna system 10 may be implemented with a second substrate (not shown) and a second ground plane (not shown). Such an arrangement (as shown in FIG. 5) may be used with antenna system 10 of FIG. 4.

The illustrated antenna system 10 also may have a copper ground plane 60 affixed to substrate 40 on the opposing side with respect to patch antenna 50. A through hole 310 may extend through a portion of the copper ground plane 60 and substrate 40 to facilitate electrical communication between the center conductor element 110 of GPS antenna cable feed 100 and patch antenna 50. Furthermore, GPS antenna cable feed 100 may be soldered onto ground plane 60 to provide support, stabilization, and electrical ground.

Center conductor element 90 may be communicatively coupled to mono-bow antenna 30 and extend through patch antenna 50, substrate 40, and ground plane 60 into a bow-cone RF interconnect connector 95. Bow-cone RF interconnect connector 95 includes a portion of center conductor element 90, a barrel 80, and a metal ground 70. For example, the bow-cone RF interconnect may be an s-band multiple access (SMA) connector.

In the illustrated embodiment, the 90-degree mounting arrangement with respect to mono-bow antenna 30 and patch antenna 50 allows the dual antennas to efficiently operate with minimal RF interference. This minimal interference may be achieved by arranging the dual antennas so that the separate reception patterns are in perpendicular planes and have minimal overlap.

FIG. 6 is a diagram illustrating a cutaway side profile view of integrated antenna system 10 of FIG. 1 that includes a GPS low noise amplifier (LNA) 180. This embodiment may include antenna system 10 having mono-bow antenna 30, patch antenna 50, and substrate 40. Similar to the embodiments illustrated and described in FIGS. 4 and 5, patch antenna 50 may be supported by substrate 40. Mono-bow antenna 30 may be mounted on patch antenna 50 using two footpads 35 that may extend through patch antenna 50 and into substrate 40.

A copper ground plane 60 may separate substrate 40 from substrate 42. A via or through hole 310 may extend through substrates 40 and 42 as well as the interstitial ground plane 60. Through hole 310 may provide access for conductive element 312 to make electrical communication between patch antenna 50 and elements on the underside of substrate 42. For example, GPS LNA 180 may be disposed on the underside of substrate 42 and be in electrical communication with conductive element 312 through transmission lines 72. Transmission lines 72 may be etched onto substrate 42. Additionally, GPS LNA 180 may be communicatively coupled with center conductor element 110 of GPS antenna cable feed 100 via etched transmission lines 73. Furthermore, GPS antenna cable feed 100 may be soldered onto ground plane 62 to provide support, stabilization, and electrical ground.

Center conductor element 90 may be communicatively coupled with mono-bow antenna 30 and extend through patch antenna 50, substrate 40, ground plane 60, substrate 42 and a second ground plane 62 into bow-cone RF interconnect connector 95. Bow-cone RF interconnect connector 95 may include a portion of center conductor element 90, connector 80 and metal ground 70. Metal ground 70 may be seated upon copper ground plane 62. The bow-cone RF interconnect may be, for example, an SMA connector.

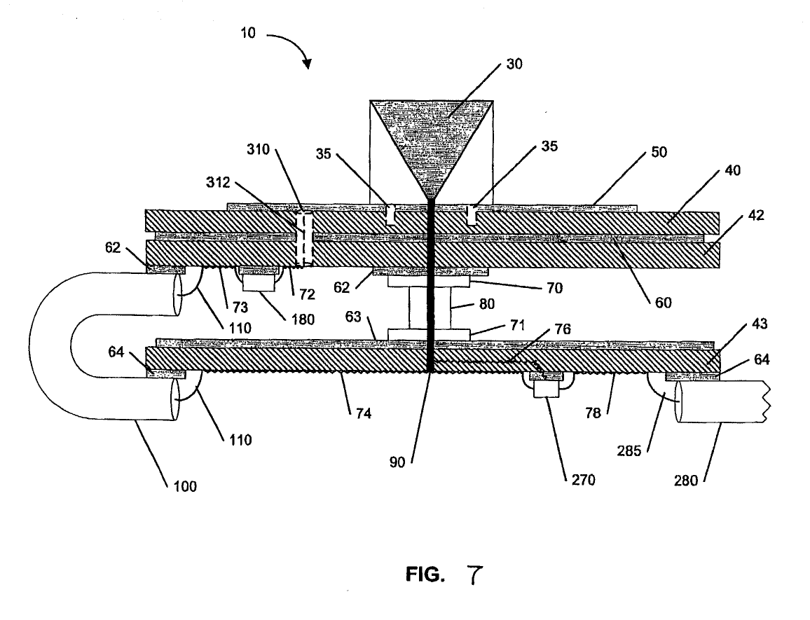

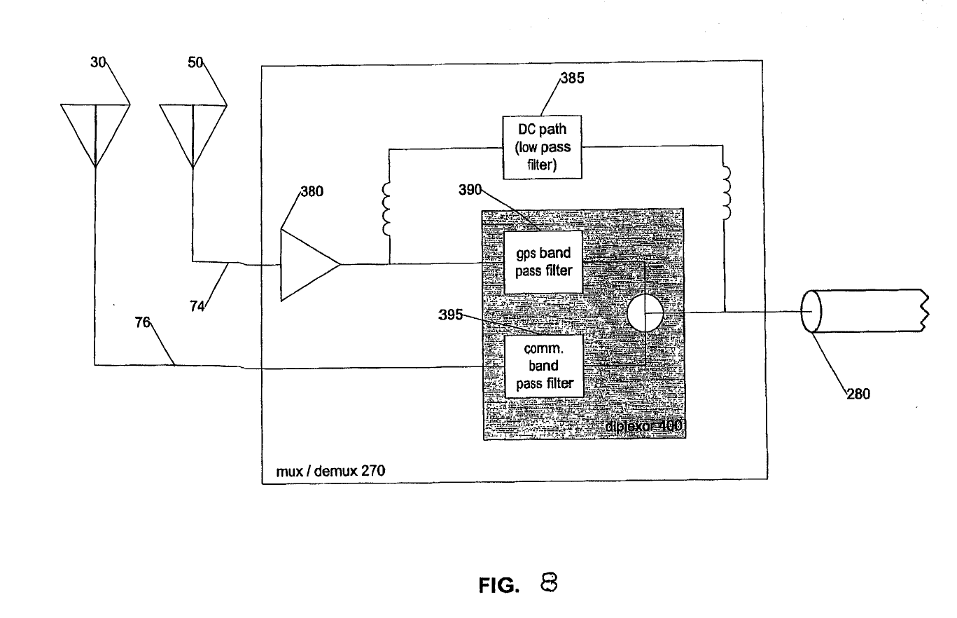

FIG. 7 is a cutaway side profile view of another embodiment of integrated antenna system 10 of FIG. 1. This embodiment includes antenna system 10 having mono-bow antenna 30, patch antenna 50 and substrate 40. Patch antenna 50 may be supported by substrate 40. Mono-bow antenna 30 may be mounted on patch antenna 50 by way of a pair of footpads 35 that may extend through patch antenna 50 and partially into substrate 40. Alternatively, footpads 35 may extend completely through substrate 40.

Copper ground plane 60 may separate substrate 40 from substrate 42. A via or through hole 310 may extend through both substrates 40 and 42, as well as interstitial ground plane 60. Through hole 310 may provide access for conductive element 312 to make electrical communication between patch antenna 50 and elements on the underside of substrate 42. For example, GPS LNA 180 may be disposed on the underside of substrate 42 and be in electrical communication with conductive element 312 through transmission lines 72 which are etched onto substrate 42.

Additionally, GPS LNA 180 may be communicatively coupled with center conductor element 110 of GPS antenna cable feed 100 via etched transmission lines 73. Furthermore, the GPS antenna cable feed 100 may be soldered onto ground plane 62 to provide support, stabilization, and electrical ground. The opposing end of GPS antenna cable feed 100 may be soldered to a third ground plane 64 to provide support, stabilization, and electrical ground for cable feed 100. Center conductor element 110 may be communicatively coupled with transmission line 74 that is etched into the underside of substrate 43. Transmission line 74 may electrically connect center conductor element 110 (and thereby patch antenna 50) with an RF mux/demux 270.

Furthermore, center conductor element 90 may communicatively couple mux/demux 270 through transmission line 76. Transmission line 76 may be etched onto the underside of substrate 43. For the purpose of clarity and to show that transmission line 74 and transmission line 76 are separate, transmission line 76 is illustrated within the cross section of substrate 43. However, the separate transmission lines 74 and 76 may both be etched into the underside of substrate 43 and are both in electrical connection with mux/demux 270.

Additionally, center conductor element 90 is in electrical communication with mono-bow antenna 30 at its other end. Center conductor element 90 may extend through patch antenna 50, substrate 40, ground plane 60, substrate 42, a first metal ground 70, an outer shell barrel 80, a second metal ground 71, ground plane 63 and substrate 43. Mux/demux 270 may combine the signals received from patch antenna 50 through GPS antenna cable feed 100 and the signals received from mono-bow antenna 30 through the center conductor element 90. The combined signal may then be carried over transmission line 78 that is etched into the surface of substrate 43. Transmission line 78 may communicatively couple mux/demux 270 and center conductor element 285 of the single feed cable 280. Once the single feed cable 280 receives the combined signal, the signal is carried to an LMU, which may have a corresponding mux/demux (as shown in FIG. 2).

FIG. 8 illustrates a mux/demux 270 as depicted in FIG. 6. Mux/demux 270 may receive input signals on transmission lines 74 and 76 from patch antenna 50 and mono-bow antenna 30, respectively. The GPS band location signal from patch antenna 50 may be received as an input signal on transmission line 74 and the mobile communication band signal from mono-bow antenna 30 may be received as an input signal on transmission line 76.

The input signal from GPS patch antenna 50 may be processed by GPS LNA 380 to ensure that the signal to noise ratio is adequate. Of course, if the LNA 380 is integral to mux/demux 270, it replaces the GPS LNA 180 shown and described in FIGS. 6 and 7. Both input signals may then be fed to diplexor 400, which comprises GPS band filter 390 and mobile communication band filter 395. The filters refine their respective input signals so that any signals outside of the desired frequency may be filtered out. The filtered signals may then be combined by diplexor 400 and transmitted together over single feed cable 280. The function of DC path 385 is to provide a power source to the LNA 380.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications and equivalents, which may be included within the spirit and scope of the present inventions as defined by the claims.

1. A device, comprising:
a substrate;
a patch antenna on a surface of the substrate to receive Global Positioning System (GPS) location signals;
a mono-bow antenna attached to the substrate to receive mobile communication band signals; and
a radome housing the patch antenna and the mono-bow antenna.

2. The device of claim 1, wherein the patch antenna is etched copper disposed on the substrate.

3. The device of claim 1, further comprising a multiplexer-demultiplexer to receive the GPS location signals and the mobile communication band signals and provide a combined signal.

4. The device of claim 1, wherein the patch antenna has right hand circular polarization at about 1575.42 MHz to receive the GPS location signals.

5. The device of claim 1, wherein the mono-bow antenna is mounted substantially perpendicular to the patch antenna on the surface of the substrate.

6. The device of claim 5, wherein the mono-bow antenna provides omni-directional coverage from about 1710 MHz to about 1990 MHz and receives mobile communication band signals.

7. A device, comprising:
a substrate having a conductor disposed on a surface to form a patch antenna to receive Global Positioning System (GPS) location signals;
a mono-pole antenna attached to the substrate above the patch antenna to receive mobile communication band signals; and
a radome housing the patch antenna and the mono-pole antenna.

8. The device of claim 7, further comprising a multiplexer-demultiplexer to receive the GPS location signals and mobile communication band signals and combine into a signal.

9. The device of claim 7, wherein the mono-pole antenna is attached substantially perpendicular to the surface of the substrate.

10. The device of claim 7, wherein the mono-pole antenna is a sleeve mono-pole antenna.

11. A system, comprising:
a portable communications device having a first antenna substantially perpendicular to a second antenna; and
a radome housing the first and second antenna.

12. The system of claim 11, wherein the first antenna is a patch antenna and the second antenna is a mono-pole antenna.

13. The system of claim 12, wherein the patch antenna receives Global Positioning System (GPS) location signals and the mono-pole antenna receives mobile communication band signals.

14. The system of claim 13, further comprising a multiplexer-demultiplexer to combine the GPS location signals and the cellular and mobile communication band signals into one signal.

15. The system of claim 12, wherein the patch antenna is formed on a substrate and the mono-pole antenna is attached to the substrate above the patch antenna.

16. The system of claim 12, wherein the patch antenna is configured to have right hand circular polarization at about 1575.42 MHz to receive GPS location signals.

17. The system of claim 12, wherein the mono-pole antenna provides omni-directional coverage from about 824 MHz to about 960 MHz and from about 1710 MHz to about 1990 MHz to receive mobile communication band signals.

18. A method, comprising:
receiving Global Positioning System (GPS) location signals in a patch antenna;
receiving mobile communication band signals in a mono-pole antenna;
combining the GPS location signals and the mobile communication band signals into one signal; and
housing the patch antenna and the mono-pole antenna in a radome of a portable communications device.

19. The method of claim 18, further comprising:
placing the mono-pole antenna substantially perpendicular to a surface of a substrate upon which the patch antenna is formed.

20. The method of claim 19, further comprising:
mounting the mono-bow antenna on the patch antenna using a pair of footpads that extend through the patch antenna and into the substrate.
